(19) United States
(12) Patent Application Publication
(10) Pub. No.: US 2020/0239190 A1
(43) Pub. Date: Jul. 30, 2020

(54) BEVERAGE CONTAINER LABELING SYSTEM

(71) Applicant: John William Davidson, Amityville, NY (US)

(72) Inventor: John William Davidson, Amityville, NY (US)

(21) Appl. No.: 16/853,513

(22) Filed: Apr. 20, 2020

Related U.S. Application Data
(63) Continuation-in-part of application No. 16/287,919, filed on Feb. 27, 2019.
(60) Provisional application No. 62/700,612, filed on Jul. 19, 2018.

(51) Int. Cl. B65D 23/14; B65D 23/08; B65C 3/06

(52) U.S. Cl. CPC B65D 23/14; B65C 3/065; B65D 23/085

(57) ABSTRACT

A beverage container label including a label having an outward surface, an inward surface, removable stickers, and a removable cover. The label is defined by the outward surface and the inward surface and includes the removable stickers disposed about a top edge and a bottom edge of the label. The inward surface of the label has adhesive such that the inward surface of the label is configured to be adhesively applied to a surface of a beverage container. The removable cover may be peeled off to expose the removable stickers for use. The removable stickers include graphics. The removable stickers may be selectively removed from the label and re-applied to the surface of the beverage container providing a modular, customizable, and user-arranged personalized message.

### CROSS-REFERENCE TO RELATED APPLICATION

The present application is a continuation-in-part of U.S. patent application Ser. No. 16/287,919, filed on Feb. 27, 2019, pending, which application is related to and claims priority to U.S. Provisional Patent Application No. 62/700,612 filed Jul. 19, 2018. Both of these applications are incorporated by reference in their entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### FIELD OF THE INVENTION

The present invention generally relates to the field of labels and, more specifically, relates to container labels.

### DESCRIPTION OF RELATED ART

Plastic bottles are conventional storage containers for liquid beverages. Multiple people, especially at a social event or work office setting, may drink drinking from the same style beverage bottles. Individuals may put down their drink and have difficulty identifying which bottle is theirs. Further, some beverage bottles may be dull and uninspiring—people may be looking for new ways to customize the bottles functionally. A suitable solution is desired.

U.S. Pat. No. 2016/026.4299 to Xiangdong Zhang relates to identifying graphics for beverage containers. The described identifying graphics for beverage containers include a beverage container which comprises a label. The label includes sections that are designed to be selectively removed. Graphics associated with the sections identify the removed sections.

### BRIEF SUMMARY OF THE INVENTION

Given the preceding disadvantages inherent in the known label art, the present disclosure provides a novel beverage container label. The general purpose of the present disclosures to provide a unique label for plastic bottles and cups.

A beverage container label is disclosed herein. The beverage container label includes a label having an outward-facing surface, an inward-facing surface, removable stickers, and a removable cover. Outward and inward surfaces define the label.

The label includes removable stickers disposed near the top and bottom label edges. The inward surface of the label comprises adhesive. The inward surface of the label is configured to be adhesively applied to a surface of a beverage container. The removable stickers include graphics chosen from alphanumeric characters, numeric characters, symbols, pictures, seasonal pictures, and the like displayed thereon. The removable cover is configured to be peeled off to expose the removable stickers for use. The removable stickers are configured to be selectively removed from the label and re-applied to the surface of the beverage container providing a modular, customizable, and user-arranged personalized message.

The container label including a layer with an outward surface and an inward surface, a removable cover disposed on top of the outward surface, and having an inner face containing a first adhesive and an outer face; and separately relocatable stickers disposed under the removable cover. The label also includes the inward surface contacting a second adhesive, the label is configured to adhere to the container's surface, and the label may also include a removable cover that is peelable from the layer.

Implementations may include one or more of the following features. The removable cover has a first adhesive that contacts the outward surface such that in a first position, the removable cover adheres to the outward surface and obscures the relocatable stickers. The removable cover in a second position releases from the outward surface and exposes the relocatable stickers. The container is a beverage container.

The outer face has an outer-face field large enough to identify the beverage container's beverage. And the outward surface has an outward-surface field large enough to identify the beverage container's beverage. The relocatable stickers are next to the outward-surface field. The relocatable stickers bear graphics include images containing one or more alphanumeric characters, numeric characters, symbols, pictures, and seasonal pictures.

In some versions, the layer permanently or semi-permanently adheres to the beverage container. The removable cover permanently or semi-permanently adheres to the layer, which fully encircles the beverage container. In some embodiments, the fully encircling layer is paired with a cover that encircles the container, as well. In other embodiments, the layer partially encircles the container, and the corresponding removable cover fully encircles the container. In other embodiments in which the layer partially encircles the beverage container, removable cover partially encircles the container. A method of labeling a container may include supplying the label, mounting the label to a container, moving the removable cover from the first position to the second position, removing the relocatable sticker, and attaching the relocatable sticker to the container. The container is a beverage container and can be selected from bottles, cans, and cups. The mounting-the-label-to-the-container step may include mounting the label to the container during bottling. In some versions, the user applies the label after bottling.

### BRIEF DESCRIPTION OF THE DRAWINGS

The figures which accompany the written portion of this specification illustrate embodiments and methods of use for the present disclosure, a beverage container label, constructed and operative according to the teachings of the present disclosure.

FIG. 1 is a perspective view of the beverage container label during an ‘in-use’ condition, according to an embodiment of the disclosure.

FIG. 2 is a perspective view of the beverage container label of FIG. 1, according to an embodiment of the present disclosure.

FIG. 3 is a perspective view of the beverage container label of FIG. 1, according to an embodiment of the present disclosure.

FIG. 4 is a perspective view of the beverage container label of FIG. 1, according to an embodiment of the present disclosure.

FIG. 5 is a perspective view of the beverage container label of FIG. 1, according to an embodiment of the present disclosure.

This document sets out the various versions of the present invention described with the appended drawings.

### DETAILED DESCRIPTION

As discussed above, embodiments of the present disclosure relate to labels and, more particularly, to a beverage container label as used to improve the labeling and the ability to tell multiple containers having the same style apart from each other.

Generally, the present invention provides bottles and cups with a custom label that offers customers the chance to design and create their own personalized message or label. The label includes a peelable, removable cover and includes numerous types of stickers, including letters, numbers, symbols, seasonal pictures, and many more. The product allows users to label their bottles for convenient identification, which may be especially useful at an office, a picnic, an outdoor social event, and the like.

The present invention enables individuals to express their creativity and personality on a plastic bottle. The beverage container label allows users to peel the stickers from the bottle or cup and arrange them as desired to construct a creative, personalized message. In a preferred embodiment, the stickers feature a clear or transparent background, and the label wraps around the container's circumference. Each sticker can have various typography, style, and colors, and there may be additional themed designs for holidays. People can choose how to arrange the stickers to label the bottle or cup or create inspiration or entertaining messages.

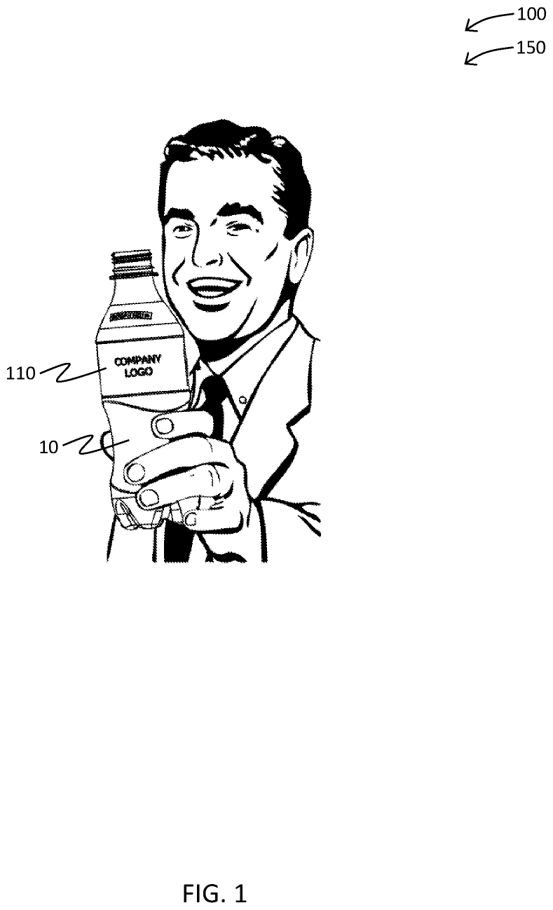

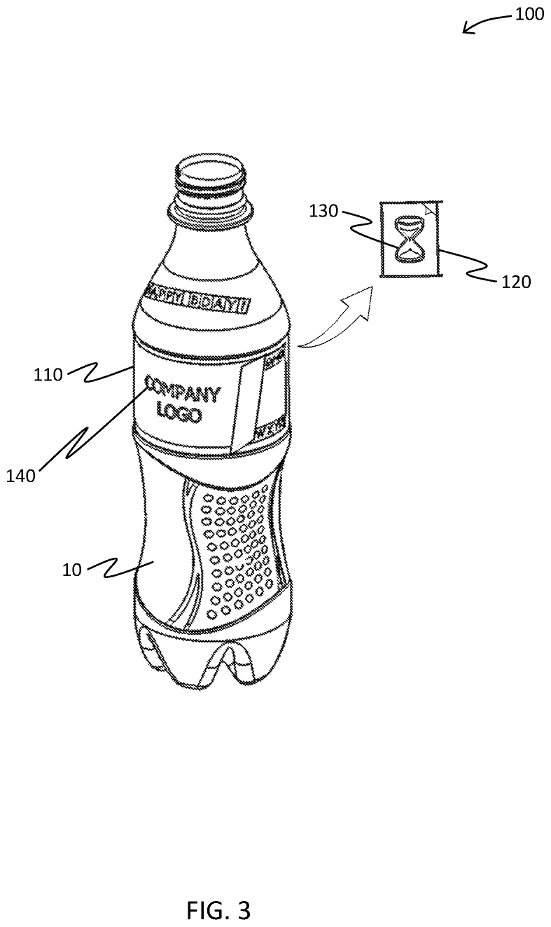

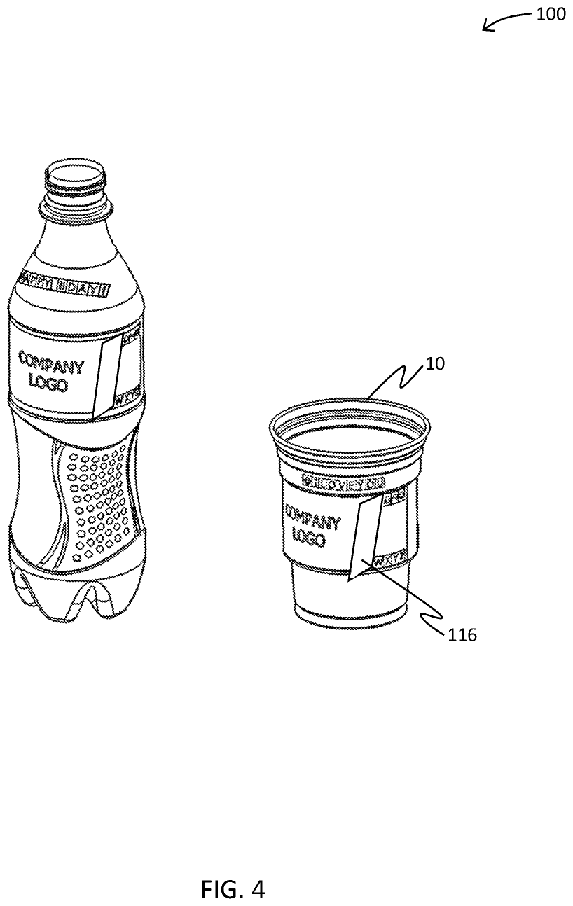

FIGS. 1-5 show various views of a beverage container labeling system.

FIG. 1 shows a beverage container label 100 during an ‘in-use’ condition 150, according to an embodiment of the present disclosure. As illustrated, the beverage container label 100 may include a label 110 having an outward surface 112, an inward surface 114, removable stickers 120, and further includes a removable cover 116. The label 110 is defined by the outward surface 112 and the inward surface 114 and includes the removable stickers 120 disposed about a top edge 122 and a bottom edge 124 of the label 110. The inward surface 114 of the label 110 may comprise an adhesive or other suitable attachment or removable attachment means. The inward surface 114 of the label 110 is configured to be applied to a surface of a beverage container 10. The removable stickers 120 contain functional graphics 130. The removable cover 116 is configured to be peeled open to expose the removable stickers 120 for use. The removable stickers 120 are configured to be selectively removed from the label 110 and re-applied to the surface of the beverage container 10 providing a modular, customizable, and user-arranged personalized message.

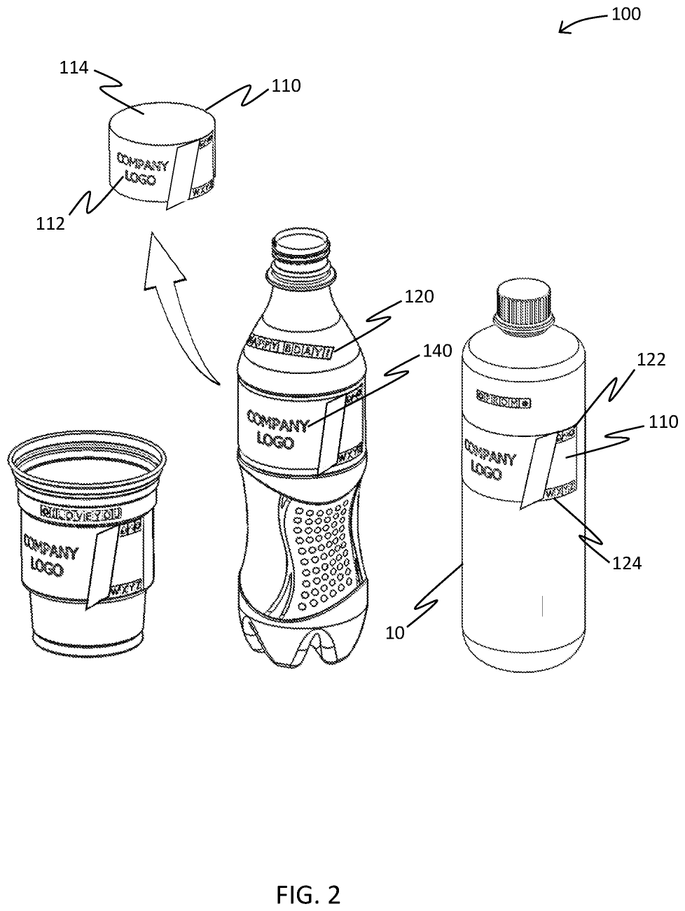

FIGS. 2-4 show various perspective views of the beverage container label 100 of FIG. 1, according to an embodiment of the present disclosure. As above, the beverage container label 100 may include label 110 applied to a beverage container 10. The label 110 may be applied to a beverage container 10 at a time of manufacturing or user applied after manufacturing. The label 110 is defined by two layers, a first-layer being the label 110 and a second-layer being the removable cover 116.

The removable cover 116 is glued to the label 110 with a first adhesive or adhesive-type material having enough holding power to maintain the removable cover 116 on top of label 110 and is configured to be removed to expose the removable stickers 120 and the outward surface 112 of the label 110. Thus, the adhesive or adhesive-type material's holding power allows manual removal from the surface of removable cover 116. In some embodiments, removable cover 116 is completely removable from label 110. In other embodiments, removable cover 116 is removable from label 110 but maintaining a connection to label 110. In other words, removable cover 116 is removable from label 110, but in some embodiments, it is not detachable from label 110. In some of these embodiments, part of removable cover 116 is glued to label 110 with a second adhesive or adhesive-type material having enough holding power to thwart detaching removable cover 116 from label 110. In some embodiments, the second adhesive or adhesive-type material is selected from glues and other materials that bond part of removable cover 116 to label 110 permanently or semi-permanently, in that removal would destroy one or both of removable cover 116 and label 110. For instance, the second adhesive for purposes of this disclosure includes a heat-seal connection between removable cover 116 and label 110. The removable cover 116 may further include a pull tap for assisting a user in removing the removable cover 116. The label 110 is configured to provide a visual indicator for readily identifying a beverage container 10. The label 110 may partially or fully encircle a beverage container 10.

The first adhesive or adhesive-type material contacts removable cover 116 over substantially all of the surface of removable cover 116. In other embodiments the first adhesive or adhesive-type material contacts removable cover 116 over 10%, 20%, 30%, 40%, 50%, 60%, 70%, 80%, 90%, and 95% of the surface of removable cover 116. Those of ordinary skill in the art recognize that the degree of coverage depends on the holding power of the first adhesive. Versions in which the first adhesive sits between removable cover 116 and label 110 are contemplated. Versions in which removable cover 116 is opaque are contemplated. For purposes of this disclosure, “opaque” means that the printed matter on label 110 is obscured by removable cover 116, causing, in some versions, printed matter on removable cover 116 to predominate when the container is viewed or marketed. In some versions, removable cover 116 doesn't have any amount of the first adhesive gluing part of removable cover 116 to another part of removable cover 116. In these or other embodiments, removable cover 116 only contacts label 110. For purposes of this disclosure, “only contacts” means that removable cover 116 contacts label 110 but does not contact the beverage container 10 directly.

Versions in which the same material is used for constructing removable cover 116 and label 110 are contemplated. Versions in which removable cover 116 and label 110 have substantially equal heights are contemplated. For purposes of this disclosure, substantially the same height means that the heights are within 1 to 10%, 2 to 8%, or 3 to 7% of each other.

The removable stickers 120 are transparent in some embodiments. The removable stickers 120 may be formed in a transparent layer, which includes sections with the functional graphics 130 displayed thereon. The removable stickers 120 are detachable from one another such that they can be removed and arranged by a user. In other embodiments, the removable stickers 120 may be non-transparent. The functional graphics 130 may include alphanumeric characters, numeric characters, symbols, pictures, seasonal pictures, and the like.

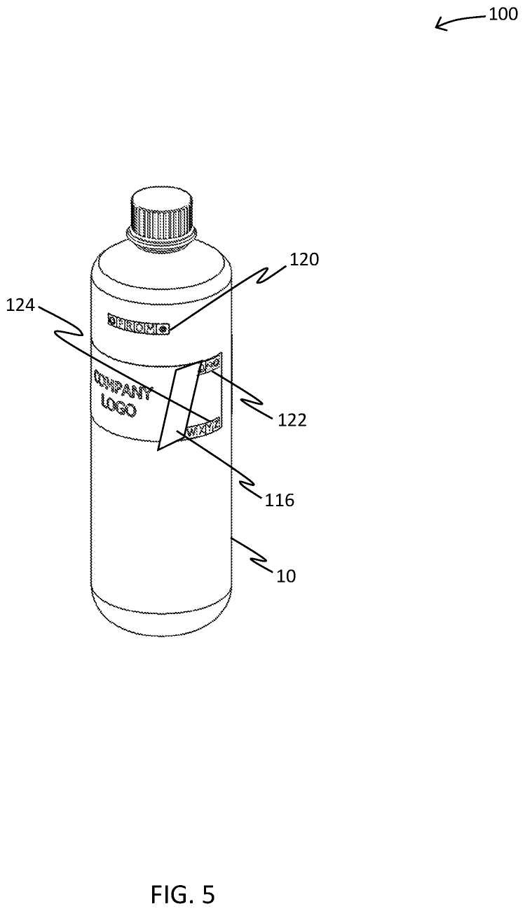

FIG. 5 shows a perspective view of the beverage container label 100 of FIG. 1, according to an embodiment of the present disclosure. As above, the beverage container label 100 may include the label 110 having the outward surface 112, the inward surface 114, the removable stickers 120, and the removable cover 116. In this embodiment, the label 110 further includes a company-logo-section 140 for indicating a specific beverage-brand of the beverage container 10. The company-logo-section 140 may be positioned on the removable cover 116 or the outward surface 112 of the label 110. The removable stickers 120 are preferably transparent and form a transparent layer configured at the top edge 122 and the bottom edge 124 of the label 110. The transparent layer includes sections with the functional graphics 130 displayed thereon. The functional graphics 130 may include alphanumeric characters, numeric characters, symbols, pictures, seasonal pictures, and the like. The removable stickers 120 are detachable from one another. The label 110 is flexible and contours to a body of the beverage container 10.

The embodiments of the invention described herein are exemplary, and numerous modifications, variations, and rearrangements can be readily envisioned to achieve substantially equivalent results, all of which are intended to be embraced within the spirit and scope of the invention.

What is claimed is:

1. A container label comprising:
a layer with an outward surface and an inward surface;
a removeable cover disposed on top of the outward surface and having an inner face containing a first adhesive and an outer face;
and
separately relocatable stickers disposed under the removable cover,
wherein the inward surface contacts a second adhesive and is configured to adhere to the container's surface,
and
wherein the removeable cover is peelable from the layer.

2. The label of claim 1, wherein the first adhesive contacts the outward surface such that in a first position the removeable cover adheres to the outward surface and obscures the relocatable stickers and in a second position the removable cover releases from the outward surface and exposes the relocatable stickers.

3. The label of claim 2 wherein the container is a beverage container.

4. The label of claim 3, wherein the outer face has an outer-face field large enough to identify the beverage container's beverage.

5. The label of claim 4, wherein the outward surface has an outward-surface field large enough to identify the beverage container's beverage.

6. The label of claim 5, wherein the relocatable stickers are next to the outward-surface field.

7. The label of claim 6, wherein the relocatable stickers bear indicia including an image containing one or more of alphanumeric characters, numeric characters, symbols, pictures, and seasonal pictures.

8. The label of claim 7, wherein the layer permanently or semi-permanently adheres to the beverage container.

9. The label of claim 8, wherein the removable cover permanently or semi-permanently adheres to the layer.

10. The label of claim 9, wherein the layer fully encircles the beverage container.

11. The label of claim 10 wherein the removable cover fully encircles the beverage container.

12. The label of claim 11, wherein the beverage container is selected from the group consisting of bottles, cans, and cups.

13. The label of claim 9, wherein the layer partially encircles the beverage container.

14. The label of claim 13 wherein the removable cover fully encircles the beverage container.

15. The label of claim 9, wherein the layer partially encircles the beverage container.

16. The label of claim 15 wherein the removable cover partially encircles the beverage container.

17. A method of labeling a container comprising:
supplying the label of claim 2;
mounting the label to a container;
moving the removable cover from the first position to the second position;
removing the relocatable sticker;
and
attaching the relocatable sticker to the container.

18. The method of claim 17, wherein the container is a beverage container.

19. The method of claim 18, wherein the mounting the label to container step comprises mounting the label to the container during bottling.

20. The method of claim 18, wherein the label is user applied after bottling.
